(19) United States
(12) Patent Application Publication
(10) Pub. No.: US 2026/0266396 A1
(43) Pub. Date: Sep. 10, 2026

(54) VALVE TRIM APPARATUS HAVING GROOVES TO REDUCE CAVITATION

(71) Applicant: Fisher Controls International LLC, Marshalltown, IA (US)

(72) Inventors: Cory A. Hagen, Johnston, IA (US); Katherine N. Bartels, Ames, IA (US)

(21) Appl. No.: 19/073,628

(22) Filed: Mar. 7, 2025

(51) Int. Cl. F16K 47/04; F16K 1/36; F16K 39/02; F16K 47/08

(52) U.S. Cl. CPC F16K 47/04; F16K 1/36; F16K 47/08; F16K 39/022

(57) ABSTRACT

A valve trim apparatus having grooves to reduce cavitation is disclosed. An example valve assembly includes a valve body, a fluid inlet and a fluid outlet defined in the valve body, a cage positioned in the valve body between the fluid inlet and the fluid outlet, the cage including grooves in an inner surface of the cage, and a plug positioned in and movable within the cage between an open position and a closed position, the plug to restrict flow of fluid from the fluid inlet to the fluid outlet when the plug is in the closed position, the fluid to flow through the grooves from the fluid inlet to the fluid outlet when the plug is in the open position, the grooves to direct the fluid toward the fluid outlet and away from the plug.

### FIELD OF THE DISCLOSURE

This disclosure relates generally to valves and, more particularly, to valve trim apparatus having grooves to reduce cavitation.

### BACKGROUND

Valves are used to control flow of a fluid through a conduit. Valves commonly include a plug movable relative to a valve cage through which fluid can flow when the valve is opened. As the fluid exits a chamber of the valve to a fluid outlet, the fluid typically interacts with a relatively stationary or low-velocity fluid at the fluid outlet. Such interaction commonly results in cavitation and/or noise.

### SUMMARY

An example valve assembly disclosed herein includes a valve body, a fluid inlet and a fluid outlet defined in the valve body, a cage positioned in the valve body between the fluid inlet and the fluid outlet, the cage including grooves in an inner surface of the cage, and a plug positioned in and movable within the cage between an open position and a closed position, the plug to restrict flow of fluid from the fluid inlet to the fluid outlet when the plug is in the closed position, the fluid to flow through the grooves from the fluid inlet to the fluid outlet when the plug is in the open position, the grooves to direct the fluid toward the fluid outlet and away from the plug.

An example valve trim disclosed herein includes a cage to be positioned in a valve body between a fluid inlet and a fluid outlet of the valve body, the cage including grooves in an inner surface of the cage, and a plug positioned in and movable within the cage between an open position and a closed position, the plug to restrict fluid flow between the fluid inlet and the fluid outlet when the plug is in the closed position, the fluid to flow through the grooves from the fluid inlet to the fluid outlet when the plug is in the open position, the grooves to direct the fluid toward the fluid outlet and away from the plug.

An example valve cage disclosed herein is to be positioned in a valve body between a fluid inlet and a fluid outlet. The valve cage includes an inner surface and an outer surface, fluid from the fluid inlet to flow from the outer surface to the inner surface and from the inner surface to the fluid outlet, and grooves in the inner surface, the grooves to direct the fluid toward the fluid outlet and away from a central longitudinal axis of the valve cage.

### BRIEF DESCRIPTION OF THE DRAWINGS

FIG. 1 is a cross-sectional view of an example valve assembly in which examples disclosed herein may be implemented.

FIG. 2 is a cross-sectional view of the example valve assembly of FIG. 1, with the plug made transparent.

FIG. 3 illustrates an example graph representative of example pressures of fluid flowing through the valve assembly of FIGS. 1 and/or 2.

FIG. 4 is a cross-sectional view of the example valve assembly of FIGS. 1 and/or 2 with the plug in a closed position.

FIG. 5 is a cross-sectional view of the example valve assembly of FIGS. 1, 2, 3, and/or 4 with the plug removed.

FIG. 6 is a cross-sectional view of a second example cage that may be implemented in the valve assembly of FIGS. 1, 2, 4, and/or 5.

FIG. 7 is a perspective view of the example plug of FIGS. 1, 2, and/or 4.

FIG. 8 is a cross-sectional view of a second example valve assembly constructed in accordance with teachings of this disclosure.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Valves are commonly implemented on a fluid conduit to control flow of fluid from a first location to a second location. When a valve is in a closed position, the valve can prevent and/or restrict fluid from a high-pressure region at an inlet of the valve from flowing to a low-pressure region at an outlet of the valve. Alternatively, when the valve is in an open position, the valve enables and/or allows the fluid to flow from the high-pressure region to the low-pressure region. Opening and closing of the valve can be performed manually or via a command signal from a process control system operatively coupled to the valve.

A trim assembly of a valve commonly includes a cage to reduce pressure of the fluid flowing through the valve. A plug is positioned in and/or movable relative to the cage to stroke the valve between the open and closed positions. In particular, the plug blocks (e.g., restricts, prevents) fluid flow through the cage in the closed position, and the plug allows (e.g., enables) fluid flow through the cage in the open position. In some cases, positioning the plug in a partially open position (e.g., between the closed position and the open position) can reduce a flow rate of the fluid compared to the flow rate of the fluid when the plug is in the fully open position.

In some cases, a sudden pressure drop though the valve can occur during and/or after movement of the plug from the closed position to the open position. In particular, fluid may be at a relatively high pressure upon entering the valve at a fluid inlet, and the fluid may be at a reduced pressure upon exiting the valve at a fluid outlet. In some instances, the fluid increases in velocity as the fluid travels through the valve and/or the cage. As the high-velocity fluid exits the valve, the high-velocity fluid interacts with relatively stationary or low-velocity fluid at the fluid outlet. Such interaction of fluids may result in noise. Further, the pressure drop through the valve during opening and/or throttling of the valve may result in cavitation. In such cases, bubbles in the fluid are formed and then subsequently collapse, which may result in increased wear and/or damage to one or more components of the valve.

Examples disclosed herein can reduce the occurrence of noise and/or cavitation during operation of a valve by producing a gradual and/or stepped (e.g., staged) pressure drop across a cage of the valve. An example valve assembly disclosed herein includes an example valve body, a fluid inlet and a fluid outlet defined in the valve body, and an example cage positioned in the valve body between the fluid inlet and the fluid outlet. In examples disclosed herein, the cage includes example grooves positioned in an inner surface of the cage. An example plug is positioned in and movable within the cage between an open position and a closed position. When the plug is in the closed position, the plug engages a valve seat of the cage to restrict fluid flow from the fluid inlet to the fluid outlet. Conversely, when the plug is in the open position, the plug is spaced apart from the valve seat to enable the fluid to flow from the fluid inlet to the fluid outlet via successive stages of the grooves. In some examples, the flow of the fluid through the grooves results in a gradual and/or staged pressure drop of the fluid, which can reduce cavitation (e.g., compared to when a sudden and/or rapid pressure drop occurs in the cage). Further, in some examples, the grooves are curved and/or angled (e.g., slanted) such that the grooves direct the fluid toward the fluid outlet (e.g., in a longitudinal direction of the plug and/or the cage) and away from (e.g., radially outward from) the plug. In some examples, by directing the fluid flow away from the plug, the grooves can reduce damage to and/or wear of the plug.

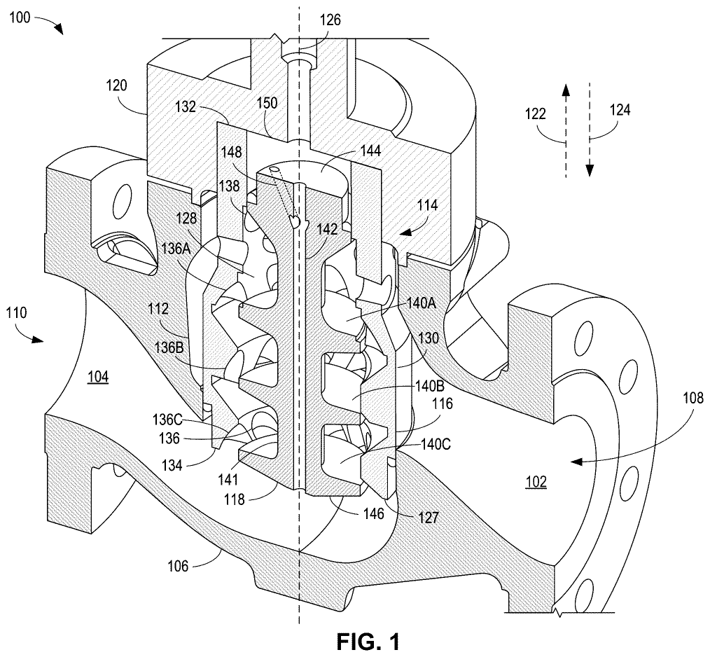

FIG. 1 is a cross-sectional view of an example valve assembly 100 in which examples disclosed herein may be implemented. In the illustrated example of FIG. 1, the valve assembly 100 can be used to control flow of fluid between a high-pressure region 102 and a low-pressure region 104. In some examples, fluid at the high-pressure region 102 is at a first pressure, and fluid at the low-pressure region 104 is at a second pressure, where the first pressure is greater than the second pressure. In some examples, a pressure drop (e.g., a pressure difference) between the high-pressure region 102 and the low-pressure region 104 is at least 5000 psi. In some examples, the pressure drop may be different (e.g., less than 5000 psi).

In the illustrated example of FIG. 1, the valve assembly 100 includes an example body (e.g., a valve body) 106 defining an example inlet (e.g., a fluid inlet) 108, an example outlet (e.g., a fluid outlet) 110, and an example fluid passageway 112 extending and/or fluidly coupled between the inlet 108 and the outlet 110. In some examples, the inlet 108 can receive fluid (e.g., high-pressure fluid) from the high-pressure region 102, and the fluid can flow to the outlet 110 and to the low-pressure region 104 via the fluid passageway 112.

In the illustrated example of FIG. 1, an example trim assembly (e.g., a valve trim assembly) 114 is positioned in the fluid passageway 112. The trim assembly 114 includes an example cage (e.g., a valve cage) 116 positioned in the fluid passageway 112 between the inlet 108 and the outlet 110, and an example plug (e.g., a valve plug) 118 positioned in and movable within the cage 116. Further, an example bonnet (e.g., a valve bonnet) 120 is coupled to the body 106. In some examples, the plug 118 can move (e.g., translate) in a first direction 122 (e.g., a first longitudinal direction, upward and/or toward the bonnet 120 in FIG. 1) and in a second direction 124 (e.g., a second longitudinal direction, downward and/or away from the bonnet 120 in FIG. 1) along an example longitudinal axis (e.g., a central longitudinal axis) 126 of the plug 118 and/or the cage 116.

In the illustrated example of FIG. 1, the cage 116 includes a cage wall 127 having an example inner surface 128 and an example outer surface 130 extending between a first end 132 and a second end 134 of the cage 116. In this example, the first end 132 is proximate the bonnet 120, and the second end 134 is proximate the fluid outlet 110. The cage 116 further includes example grooves 136 in the inner surface 128, including first grooves 136A spaced along a first circumference of the inner surface 128, second grooves 136B spaced along a second circumference of the inner surface 128, and third grooves 136C spaced along a third circumference of the inner surface 128. In this example, the second grooves 136B are spaced apart from the first grooves 136A in the second direction 124 (e.g., the second grooves 136B are downstream of the first grooves 136A), and the third grooves 136C are spaced apart from the second grooves 136B in the second direction 124 (e.g., the third grooves 136C are downstream of the first grooves 136A and the second grooves 136B). In some examples, a number of the grooves 136 increases in the second direction 124 (e.g., from the first end 132 to the second end 134 of the cage 116). For example, a first number of the first grooves 136A is less than a second number of the second grooves 136B, and the second number of the second grooves 136B is less than a third number of the third grooves 136C.

Further, the cage 116 includes example inlet ports (e.g., fluid inlet ports) 138 upstream of the grooves 136, where the inlet ports 138 extend between the inner surface 128 and the outer surface 130 of the cage 116. In this example, the inlet ports 138 extend in a radial direction (e.g., radially outward from the longitudinal axis 126) from the inner surface 128 to the outer surface 130. In some examples, one or more of the inlet ports 138 can extend in a different direction (e.g., a non-radial direction, a direction angled relative to the radial direction) from the inner surface 128 to the outer surface 130.

In the illustrated example of FIG. 1, the plug 118 includes an example stem portion 141 and first, second, and third example flanged portions 140A, 140B, 140C (collectively referred to herein as flanged portions 140) extending (e.g., in a radial direction) from the stem portion 141. In this example, the flanged portions 140 are spaced apart along the longitudinal axis 126 of the cage 116 and/or the plug 118 (e.g., the second flanged portion 140B is spaced apart from the first flanged portion 140A in the second direction 124, and the third flanged portion 140C is spaced apart from the second flanged portion 140B in the second direction 124). In the illustrated example of FIG. 1, the plug 118 further includes a first example hole (e.g., a first through-hole) 142 extending between a first surface 144 of the plug 118 (e.g., proximate the first end 132 of the cage 116) and a second surface 146 of the plug 118 (e.g., proximate the second end 134 of the cage 116), where the first hole 142 extends (e.g., is oriented) along the longitudinal axis 126 in this example. Further, the plug 118 includes a second example hole (e.g., a second through-hole) 148 extending from the first hole 142 to the first surface 144, where the second hole 148 is angled (e.g., is at an angular offset) relative to the first hole 142 and/or the longitudinal axis 126. In some examples, the plug 118 can include one or more additional holes extending between the first hole 142 and the first surface 144.

In some examples, the first hole 142 is used during installation and/or positioning of the plug 118 in the cage 116, and/or can be used to operatively couple an actuator to the plug 118 (e.g., where the actuator can move the plug 118 in the first and second directions 122, 124). In some examples, the first hole 142 and/or the second hole 148 can fluidly couple the outlet 110 to an example chamber 150 defined in the trim assembly 114 between the first surface 144 of the plug 118, the inner surface 128 of the cage 116, and the bonnet 120. In some examples, fluid from the low-pressure region 104 at the outlet 110 can flow to the chamber 150 via the first hole 142 and/or the second hole 148 to enable pressure balancing between the chamber 150 and the outlet 110 (e.g., to enable a pressure in the chamber 150 to be substantially equal to the pressure at the outlet 110). In some examples, such pressure balancing can prevent premature actuation (e.g., throttling) of the valve assembly 100 between the open and closed positions.

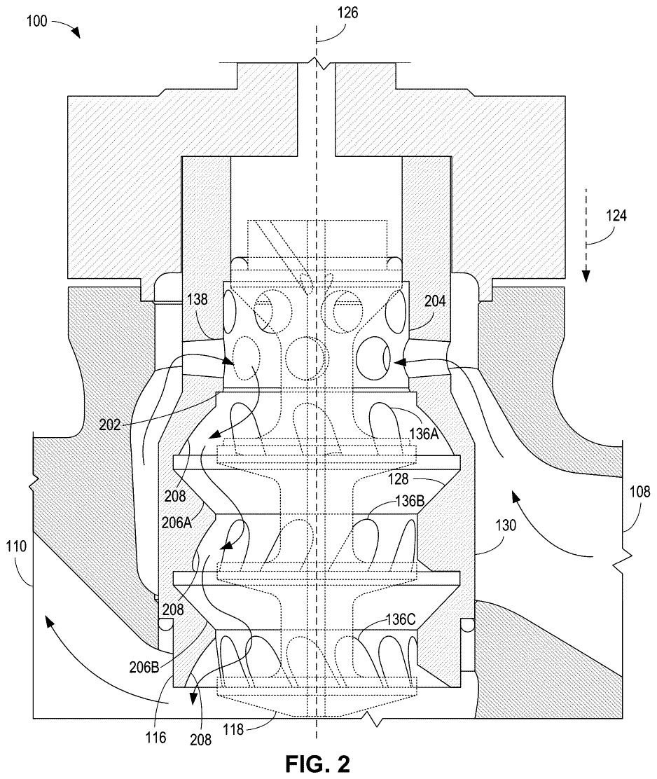

In the illustrated example of FIG. 1, the valve assembly 100 is shown in an open position. When the plug 118 is in the open position, the plug 118 uncovers and/or enables fluid flow to and/or through the grooves 136, such that fluid can flow from the inlet 108 to the outlet 110 via the grooves 136. An example flow path of fluid through the valve assembly 100 in the open position is described in connection with FIG. 2 below.

FIG. 2 is a cross-sectional view of the example valve assembly 100 of FIG. 1, with the plug 118 made transparent. In the illustrated example of FIG. 2, the plug 118 is in an open position in which the plug 118 is spaced apart (e.g., in the second direction 124) from and does not contact an example valve seat 202 defined by the inner surface 128 of the cage 116. In this example, when the plug 118 is in the open position, fluid from the inlet 108 flows into an inlet region 204 of the cage 116 (e.g., from the outer surface 130 to the inner surface 128) via the inlet ports 138. In this example, the inlet ports 138 are circular (e.g., have a circular cross-sectional shape). In some examples, the inlet ports 138 can have a different cross-sectional shape (e.g., rectangular, hexagonal, elliptical, etc.).

In the illustrated example of FIG. 2, the fluid that enters the inlet region 204 via the inlet ports 138 can then flow through the first grooves 136A to a first cavity (e.g., a first pressure recovery region) 206A defined in the cage 116. For example, the inner surface 128 defines the first cavity 206A in a first concave portion of the cage 116 between first grooves 136A and the second grooves 136B. As a result of the first grooves 136A restricting an area through which the fluid can flow from the inlet region 204 to the first cavity 206A, a pressure of the fluid drops (e.g., is reduced) when the fluid flows through the first grooves 136A. In such examples, the fluid in the inlet region 204 is at a first pressure, and the fluid in the first cavity 206A is at a second pressure less than the first pressure. In some examples, pressure recovery (e.g., pressure increase and/or pressure stabilization) occurs in the first cavity 206A. In some examples, a first pressure drop through the first grooves 136A and a first pressure recovery in the first cavity 206A corresponds to a first stage of fluid flow through the valve assembly 100.

In some examples, the fluid in the first cavity 206A flows through the second grooves 136B to a second example cavity (e.g., a second pressure recovery region) 206B defined in the cage 116. In this example, the inner surface 128 defines the second cavity 206B in a second concave portion of the cage 116 between the second grooves 136B and the third grooves 136C. In some examples, as a result of the second grooves 136B restricting an area through which the fluid can flow from the first cavity 206A to the second cavity 206B, the pressure of the fluid further drops (e.g., is reduced) when the fluid flows through the second grooves 136B. In such examples, the pressure of the fluid drops from the second pressure in the first cavity 206A to a third pressure (e.g., less than the second pressure) in the second cavity 206B. In some examples, pressure recovery (e.g., pressure increase and/or pressure stabilization) occurs in the second cavity 206B. In some examples, a second pressure drop through the second grooves 136B and a second pressure recovery in the second cavity 206B corresponds to a second stage of fluid flow through the valve assembly 100.

In the illustrated example of FIG. 2, the fluid in the second cavity 206B flows through the third grooves 136C to the outlet 110 of the valve assembly 100. In such examples, the pressure of the fluid drops from the third pressure in the second cavity 206B to a fourth pressure at the outlet 110 when the fluid flows through the third grooves 136C. In some examples, In some examples, pressure recovery (e.g., pressure increase and/or pressure stabilization) occurs in the outlet 110, such that the fourth pressure substantially corresponds to a pressure at the low-pressure region 104 of FIG. 1. In some examples, a third pressure drop through the third grooves 136C and a third pressure recovery in the outlet 110 corresponds to a third stage of the fluid flow through the valve assembly 100.

In some examples, a magnitude of the pressure drop (e.g., the first pressure drop, the second pressure drop, and/or the third pressure drop) is based on a flow area of the grooves 136 through which the fluid flows. For example, the magnitude of the pressure drop can be increased by reducing the flow area through the grooves 136 and, conversely, the magnitude of the pressure drop can be reduced by increasing the flow area through the grooves 136. In some examples, the flow area can be adjusted by adjusting sizes (e.g., cross-sectional areas) of the grooves 136 and/or by adjusting a number of the grooves 136. In the illustrated example of FIG. 2, the cage 116 includes a first number of the first grooves 136A, a second number (e.g., greater than the first number) of the second grooves 136B, and a third number (e.g., greater than the second number) of the third grooves 136C. In this example, because the second number of the second grooves 136B is greater than the first number of the first grooves 136A, the second pressure drop through the second grooves 136B is less than the first pressure drop through the first grooves 136A. Similarly, because the third number of the third grooves 136C is greater than the second number of the second grooves 136B, the third pressure drop through the third grooves 136C is less than the second pressure drop through the second grooves 136B. Stated differently, the magnitude of the pressure drop decreases across subsequent ones of the stages through the cage 116.

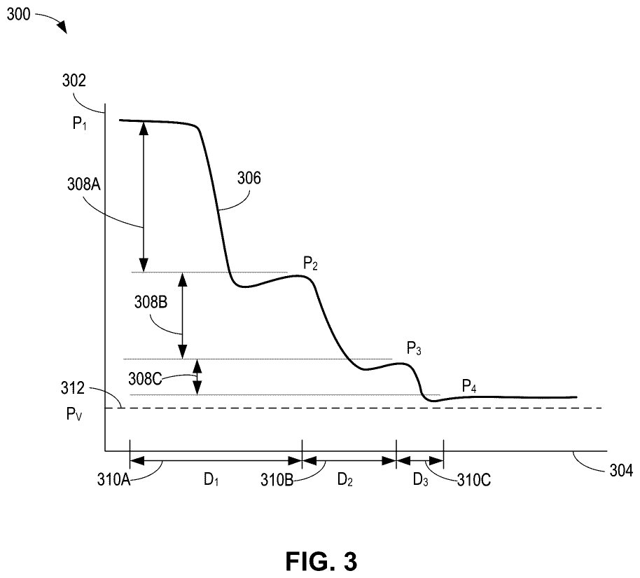

In some examples, by enabling a gradual and/or staged pressure drop of the fluid from the inlet 108 to the outlet 110, the cage 116 can reduce and/or prevent the occurrence of cavitation in the valve assembly 100. For example, FIG. 3 illustrates an example graph 300 representative of example pressures of fluid flowing through the valve assembly 100 of FIGS. 1 and/or 2. In the illustrated example of FIG. 3, the graph 300 includes a first example axis (e.g., a vertical axis) 302 representative of the pressures, and a second example axis (e.g., a horizontal axis) 304 representative of time. The origin is, for example, a start time such as a time at which the valve assembly 100 of FIGS. 1 and/or 2 throttles from the closed position to the open position. Further, an example line 306 represents the pressures of the fluid (e.g., corresponding to the first axis 302) at the respective times (e.g., corresponding to the second axis 304).

In the illustrated example of FIG. 3, a first example pressure change (e.g., a first pressure drop and pressure recovery) 308A occurs during a first stage corresponding to a first example duration 310A (e.g., during which the fluid flows from the inlet region 204 to the first cavity 206A via the first grooves 136A of FIG. 2). Further, a second example pressure change (e.g., a second pressure drop and pressure recovery) 308B occurs during a second stage corresponding to a second duration 310B (e.g., during which the fluid flows from the first cavity 206A to the second cavity 206B via the second grooves 136B of FIG. 2), and a third example pressure change (e.g., a third pressure drop and pressure recovery) 308C occurs during a third stage corresponding to a third example duration 310C (e.g., during which the fluid flows from the second cavity 206B to the outlet 110 via the third grooves 136C of FIG. 2). In this example, the pressure changes from a first example pressure (e.g., P1) to a second example pressure (e.g., P2) during the first stage, the pressure changes from the second pressure to a third example pressure (e.g., P3) during the second stage, and the pressure changes from the third pressure to a fourth example pressure (e.g., P4) during the third stage. In some examples, the first pressure P1 substantially corresponds to the pressure at the inlet 108, and the fourth pressure P4 substantially corresponds to the pressure at the outlet 110.

In some examples, at the respective stages, the pressure drops (e.g., temporarily drops) below a recovery pressure before recovering (e.g., stabilizing, increasing) to the recovery pressure. In this example, the recovery pressure in the first stage is the second pressure P2, the recovery pressure in the second stage is the third pressure P3, the recovery pressure in the third stage is the fourth pressure P4. In some examples, an amount of by which the pressure overshoots (e.g., drops below) the recovery pressure at a respective stage is based on a magnitude of the corresponding pressure drop across the stage. For example, increasing the magnitude of the pressure drop increases the amount by which the pressure can drop below the recovery pressure. In some examples, cavitation occurs when the pressure in one or more locations of the valve assembly 100 drops below a threshold pressure (e.g., a vapor pressure (Pv)) 312 of the fluid. In some examples, by reducing the magnitude of the pressure drop across subsequent ones of the stages, a likelihood of the pressure dropping below the threshold pressure 312 and, thus, a likelihood of cavitation occurring can be reduced.

Returning to FIG. 2, the grooves 136 include example curved surfaces (e.g., curved inner surfaces) 208 along which fluid can flow when travelling through respective ones of the grooves 136. For example, the curved surfaces 208 can taper outward (e.g., away from the longitudinal axis 126) in the second direction 124 (e.g., in the downward direction of FIG. 2). As a result, when the fluid flows through the grooves 136, the grooves 136 can direct the fluid downward in FIG. 2 (e.g., in the second direction 124, toward the outlet 110) and away from the longitudinal axis 126 and, thus, away from the plug 118. In some examples, by directing the fluid flow away from the plug 118, the grooves 136 can reduce damage to and/or reduce pressure on the plug 118.

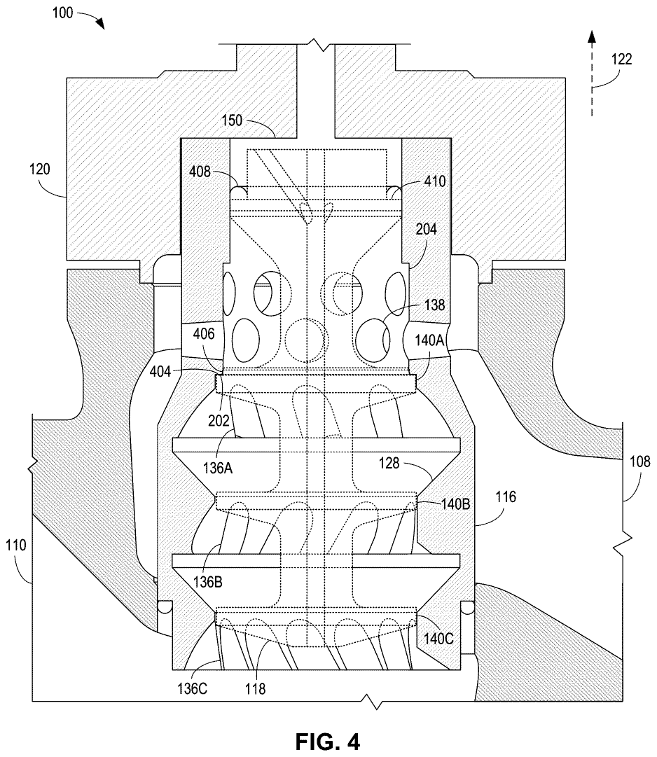

FIG. 4 is a cross-sectional view of the example valve assembly 100 of FIGS. 1 and/or 2 with the plug 118 in a closed position. In some examples, the plug 118 moves from the open position of FIGS. 1 and/or 2 to the closed position of FIG. 4 by moving upward in FIG. 4 (e.g., in the first direction 122, toward the bonnet 120) until the first flanged portion 140A of the plug 118 contacts (e.g., engages) the valve seat 202 defined by the inner surface 128 of the cage 116. In some examples, when the plug 118 is in the closed position, the plug 118 restricts and/or prevents fluid flow to and/or through the grooves 136 (e.g., to restrict the fluid flow from the inlet 108 to the outlet 110).

In this example, the first flanged portion 140A includes an example seating surface 404 to contact the valve seat 202 to prevent further movement of the plug 118 in the first direction 122 (e.g., upward in FIG. 4). Further, the first flanged portion 140A includes an example sealing surface 406 to contact (e.g., sealably engage) the inner surface 128 of the cage 116. In some examples, the sealing surface 406 prevents and/or restricts the flow of fluid from the inlet region 204 to the first grooves 136A and, thus, to the outlet 110. Further, in this example, an example seal 408 is positioned on and/or coupled to an example annular surface 410 of the plug 118, where the annular surface 410 is upstream of the inlet ports 138. In some examples, the seal 408 restricts and/or prevents leakage of fluid into and/or out of the chamber 150 (e.g., to and/or from the inlet 108).

In this example, the valve seat 202 is positioned in a portion of the cage 116 between the inlet ports 138 and the first grooves 136A. Additionally or alternatively, the valve seat 202 can be positioned in a portion of the cage 116 between the first grooves 136A and the second grooves 136B (e.g., such that the second flanged portion 140B is to contact the valve seat 202 in the closed position) and/or between the second grooves 136B and the third grooves 136C (e.g., such that the third flanged portion 140C is to contact the valve seat 202 in the closed position) in some examples.

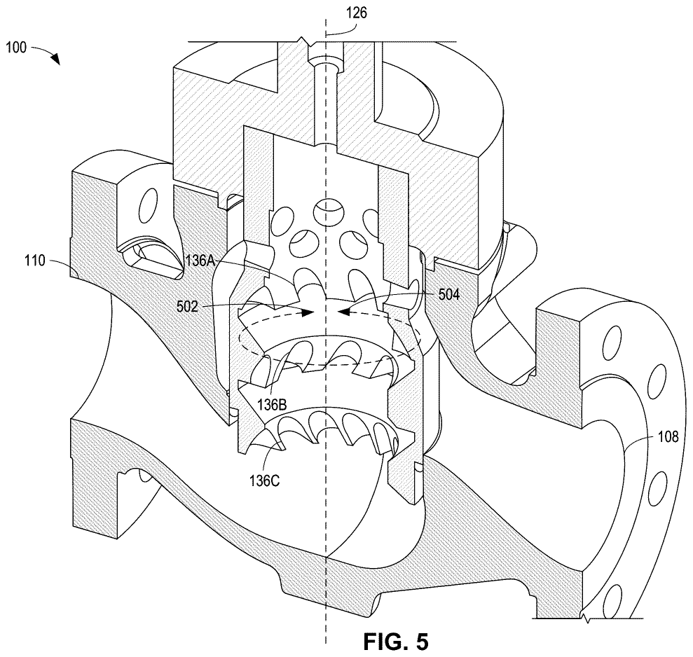

FIG. 5 is a cross-sectional view of the example valve assembly 100 of FIGS. 1, 2, 3, and/or 4 with the plug 118 removed. In the illustrated example of FIG. 5, the first grooves 136A and the third grooves 136C are slanted (e.g., angled, oriented) in a first helical direction about the longitudinal axis 126, and the second grooves 136B are slanted (e.g., angled, oriented) in a second helical direction about the longitudinal axis 126, where the second helical direction is different from the first helical direction. In some examples, in addition to directing fluid downward (e.g., in the second direction 124) in FIG. 5 and outward (e.g., radially outward) from the longitudinal axis 126, the first grooves 136A and the third grooves 136C, as a result of being slanted in the first helical direction, cause the fluid to rotate (e.g., swirl) in a first rotational direction 502 about the longitudinal axis 126 when the fluid exits the respective first grooves 136A and the third grooves 136A. Further, the second grooves 136B, as a result of being slanted in the second helical direction, cause the fluid to rotate (e.g., swirl) in a second rotational direction 504 (e.g., opposite the first rotational direction 502) about the longitudinal axis 126 when the fluid exits the second grooves 136B. Stated differently, the grooves 136 cause the fluid to rotate and/or swirl about the longitudinal axis 126 in changing (e.g., alternating and/or reversing) directions as the fluid flows through the cage 116 from the inlet 108 to the outlet 110. In some examples, as a result of the changes in rotational direction (e.g., swirl direction) of the fluid between successive stages of the cage 116, the fluid follows a more tortuous flow path through the cage 116 (e.g., compared to flow paths which require little or no change in rotational direction) which can further reduce the pressure of the fluid across the successive stages.

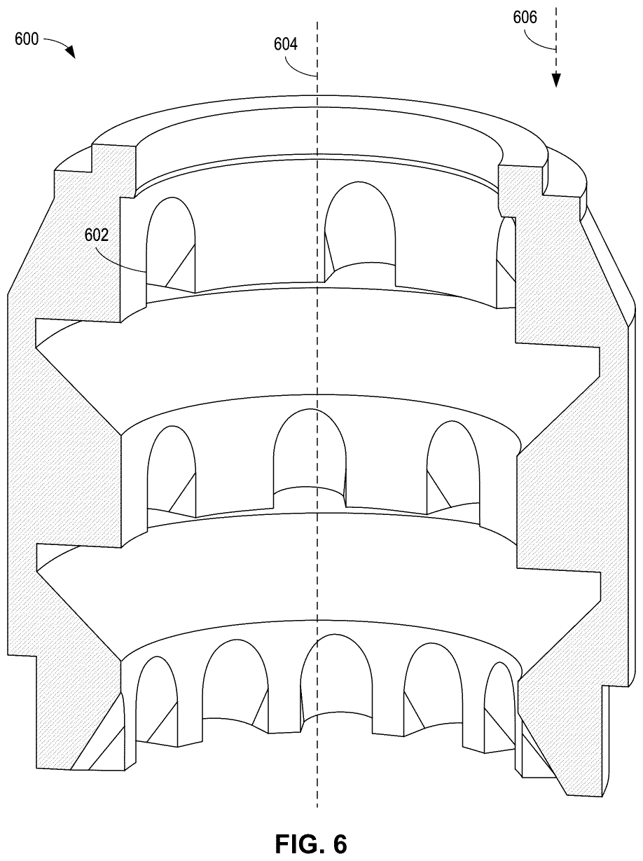

FIG. 6 is a cross-sectional view of a second example cage 600 that may be implemented in the valve assembly 100 of FIGS. 1, 2, 4, and/or 5 (e.g., instead of the cage 116 of FIGS. 1, 2, 4, and/or 5). In the illustrated example of FIG. 6, the second cage 600 is substantially similar to the cage 116 of FIGS. 1, 2, 4, and/or 5, except that the second cage 600 of FIG. 6 includes example grooves 602 that are not slanted (e.g., the grooves 602 of FIG. 6 are oriented along and/or parallel to a longitudinal axis 604 of the second cage 600). In some examples, the grooves 602 can direct fluid flowing through the second cage 600 in a first example direction 606 (e.g., downward in FIG. 6) and outward (e.g., radially outward) from the longitudinal axis 604, but the grooves 602 may not cause rotation (e.g., swirl) of the fluid about the longitudinal axis 604. In this example, the grooves 602 of FIG. 6 (e.g., similar to the grooves 136 of FIGS. 1, 2, 4, and/or 5) have U-shaped cross-sections. In some examples, a cross-sectional shape of the grooves 602 may be different (e.g., rectangular, triangular, etc.).

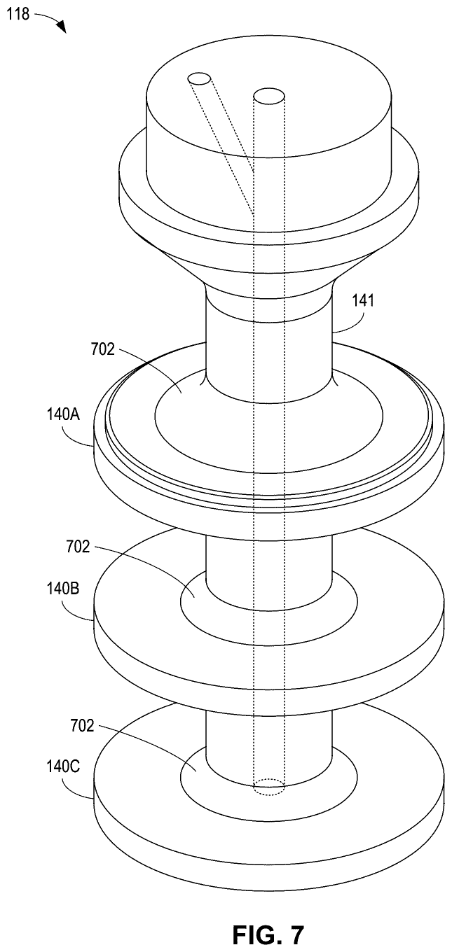

FIG. 7 is a perspective view of the example plug 118 of FIGS. 1, 2, and/or 4. In the illustrated example of FIG. 7, the plug 118 includes curved surfaces (e.g., rounded surfaces) 702 extending between respective ones of the flanged portions 140A, 140B, 140C and the stem portion 141. In this example, the flanged portions 140A, 140B, 140C have circular cross-sectional shapes. In some examples, the flanged portions 140A, 140B, 140C can have a different cross-sectional shape (e.g., elliptical, rectangular, hexagonal, etc.) that is substantially the same as and/or complementary to a cross-sectional shape of the inner surface 128 of the cage 116 of FIGS. 1, 2, 4, and/or 5.

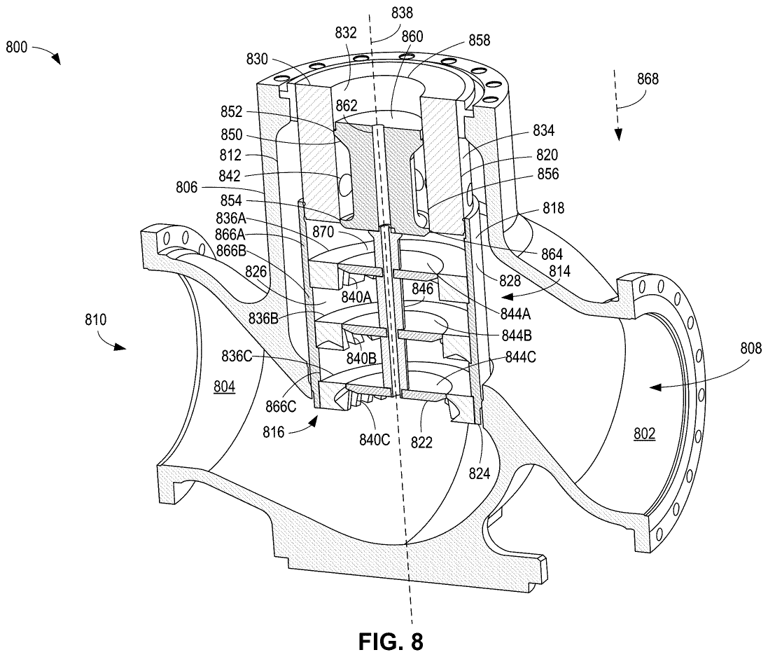

FIG. 8 is a cross-sectional view of a second example valve assembly 800 constructed in accordance with teachings of this disclosure. Similar to the valve assembly 100 of FIGS. 1, 2, 4, and/or 5, the second valve assembly 800 of FIG. 8 can be used to control flow of fluid between a high-pressure region 802 and a low-pressure region 804. The second valve assembly 800 includes an example valve body 806 defining an example inlet 808, an example outlet 810, and an example fluid passageway 812 extending and/or fluidly coupled between the inlet 808 and the outlet 810. In some examples, the inlet 808 can receive fluid (e.g., high-pressure fluid) from the high-pressure region 802, and the fluid can flow to the outlet 810 and to the low-pressure region 804 via the fluid passageway 812.

In the illustrated example of FIG. 8, the second valve assembly 800 includes an example trim assembly (e.g., a valve trim, a valve trim assembly) 814 positioned in the fluid passageway 812. The trim assembly 814 includes an example cage 816 including a lower cage 818 coupled to an upper cage 820, and an example plug 822 positioned in and movable within the cage 816. In this example, the lower cage 818 includes a first cage wall 824 having a first inner surface 826 and first outer surface 828, and the upper cage 820 includes a second cage wall 830 having a second inner surface 832 and a second outer surface 834. In this example, a first thickness of the first cage wall 824 (e.g., from the first inner surface 826 to the first outer surface 828) is less than a second thickness of the second cage wall 830 (e.g., from the second inner surface 832 to the second outer surface 834). In some examples, the lower cage 818 is coupled (e.g., threaded) to the upper cage 820 (e.g., by coupling a portion of the first inner surface 826 of the lower cage 818 to a portion of the second outer surface 834 of the upper cage 820). In some examples, the lower cage 818 is integrated with the upper cage 820 (e.g., the cage 816 is fabricated as a single part).

In the illustrated example of FIG. 8, the cage 816 includes a first example ring 836A, a second example ring 836B, and a third example ring 836C (e.g., collectively referred to herein as rings 836) coupled to and/or extending from the first inner surface 826 of the lower cage 818. In some examples, the first inner surface 826 of the lower cage 818, the second inner surface 832 of the upper cage 820, and the rings 836 define an inner surface of the cage 816. In this example, the rings 836 are spaced apart from one another along a longitudinal axis (e.g., a central longitudinal axis) 838 of the cage 816 and/or the plug 822. For example, the first ring 836A is positioned on and/or extends along a first circumference of the first inner surface 826, the second ring 836B is positioned on and/or extends along a second circumference of the first inner surface 826 (e.g., downstream of the first circumference), and the third ring 836C is positioned on and/or extends along a third circumference of the first inner surface 826 (e.g., downstream of the first circumference and the second circumference). In this example, the rings 836 are coupled (e.g., threaded, welded) to the first inner surface 826. In some examples, the rings 836 can be integrated with the lower cage 818 (e.g., the lower cage 818 and the rings 836 can be fabricated as a single part).

In the illustrated example of FIG. 8, the cage 816 includes first example grooves 840A defined in the first ring 836A, second example grooves 840B defined in the second ring 836B, and third example grooves 840C defined in the third ring 836C (where the first, second, and third grooves 840A, 840B, 840C are collectively referred to herein as grooves 840). In this example, similar to the grooves 136 of FIGS. 1, 2, 4, and/or 5, the grooves 840 of FIG. 8 are slanted with respect to the longitudinal axis 838. For example, the first grooves 840A and the third grooves 840C are slanted and/or oriented along a first direction (e.g., a first helical direction), and the second grooves 840B are slanted and/or oriented along a second direction (e.g., a second helical direction) different from the first direction. In some examples, the grooves 840 are not slanted (e.g., the grooves 840 can be oriented in a direction parallel to the longitudinal axis 838). Further, in this example, a first number of the first grooves 840A is less than a second number of the second grooves 840B, and the second number of the second grooves 840B is less than a third number of the third grooves 840C. In this example, the upper cage 820 includes example inlet ports 842 extending through the second cage wall 830 from the second inner surface 832 to the second outer surface 834 (e.g., the inlet ports 842 extend and/or are oriented along a radial direction relative to the longitudinal axis 838).

In the illustrated example of FIG. 8, the plug 822 includes a first example flanged portion 844A, a second example flanged portion 844B, and a third example flanged portion 844C (collectively referred to herein as flanged portions 844) extending from and/or coupled to an example stem portion 846 of the plug 822. In this example, the flanged portions 844 are spaced apart from one another along the longitudinal axis 838 (e.g., where a spacing between the flanged portions 844 is substantially equal to a spacing between the rings 836). Further, the plug 822 includes an example plug portion 850 coupled to the stem portion 846, where the plug portion 850 is positioned and/or slidable within the second inner surface 832 of the upper cage 820. In this example, the plug portion 850 includes a first sealing surface 852 and a second sealing surface 854 to contact and/or slide along the second inner surface 832. In some examples, the first sealing surface 852 prevents and/or restricts leakage of fluid between an inlet region 856 defined in the second inner surface 832 of the upper cage 820 and an example chamber 858 defined between the second inner surface 832 and a first end surface 860 of the plug 822 and/or the plug portion 850. In this example, an example hole 862 extending through the plug 822 along the longitudinal axis 838 fluidly couples the chamber 858 to the outlet 810 (e.g., to enable pressure balancing on the plug 822).

In the illustrated example of FIG. 8, fluid from the inlet 808 can enter the inlet region 856 of the upper cage 820 via the inlet ports 842. In this example, the plug 822 is in a closed position in which the second sealing surface 854 of the plug portion 850 contacts (e.g., engages, sealably engages) a portion of the upper cage 820 defining an example valve seat 864 of the second valve assembly 800. When the plug 822 is in the closed position of FIG. 8, the contact between the second sealing surface 854 and the valve seat 864 prevents and/or restricts leakage of fluid from the inlet region 856 to a first cavity 866A defined in the lower cage 818 between the first ring 836A and the upper cage 820. Further, when the plug 822 is in the closed position, the first flanged portion 844A blocks (e.g., restricts) fluid flow from the first cavity 866A to a second cavity 866B defined in the lower cage 818 between the first ring 836A and the second ring 836B, the second flanged portion 844B blocks (e.g., restricts) fluid flow from the second cavity 866B to a third cavity 866C defined in the lower cage 818 between the second ring 836B and the third ring 836C, and the third flanged portion 844C blocks (e.g., restricts) fluid flow from the third cavity 866C to the outlet 810.

In some examples, the plug 822 can move from the closed position of FIG. 8 to an open position by moving in a travel direction 868 (e.g., downward in FIG. 8). For example, the plug 822 in the open position is offset (e.g., in the travel direction 868) from the plug 822 in the closed position. In such examples, when the plug 822 is in the open position, the second sealing surface 854 is spaced apart from the valve seat 864, thus enabling fluid to flow from the inlet region 856 to the first cavity 866A. Further, when the plug 822 is in the open position, the flanged portions 844 are spaced apart from top surfaces 870 of the respective rings 836 to enable fluid flow to and/or through the respective grooves 840. For example, fluid from the first cavity 866A can flow to the second cavity 866B via the first grooves 840A, fluid from the second cavity 866B can flow to the third cavity 866C via the second grooves 840B, and fluid from the third cavity 866C can flow to the outlet 810 via the third grooves 840C.

In some examples, similar to the grooves 136 of FIGS. 1, 2, 4, and/or 5, the grooves 840 of FIG. 8 can direct fluid downward in FIG. 8 (e.g., in the travel direction 868, toward the outlet 810) and away from the longitudinal axis 838 and, thus, away from the plug 822. In some examples, by directing the fluid flow away from the plug 822, the grooves 840 can reduce damage to and/or reduce pressure on the plug 822. Further, a pressure of the fluid drops between successive ones of the grooves 840 (e.g., such that the pressure though the cage 816 follows a similar pattern to the pressures represented in the graph 300 of FIG. 3). In some examples, the gradual and/or staged pressure drop across the cage 816 can reduce the occurrence of cavitation in one or more locations of the second valve assembly 800.

In this example, the valve seat 864 is protected seat. In such examples, a first portion of the plug 822 (e.g., the second sealing surface 854) that engages the valve seat 864 is separate from a second portion of the plug 822 (e.g., the first flanged portion 844A) that controls the fluid flow to the first grooves 840A. Conversely, in the examples of FIGS. 1, 2, and/or 4, the valve seat 202 is in isolated seat. In such examples, a same portion of the plug 118 (e.g., the first flanged portion 140A) that engages the valve seat 202 also controls the fluid flow to the first grooves 136A. In some examples, the protected seat (e.g., the valve seat 864 of FIG. 8) may be more resistant to damage and/or wear (e.g., compared to an isolated seat such as the valve seat 202 of FIG. 2) because there is little or no pressure drop across the protected seat. Conversely, because the first flanged portion integrates the seating surface 404 (e.g., to contact the valve seat 202) with the sealing surface 406 (e.g., to restrict fluid flow to the first grooves 136A), the isolated seat configuration of FIGS. 1, 2, and/or 4 can have a reduced size compared to the protected seat configuration of FIG. 8.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately,” “substantially,” and “about” modify their subjects/values to recognize the potential presence of variations that occur in real world applications. For example, “approximately,” “substantially,” and “about” may modify dimensions that may not be exact due to manufacturing tolerances and/or other real world imperfections as will be understood by persons of ordinary skill in the art. For example, “approximately,” “substantially,” and “about” may indicate such dimensions may be within a tolerance range of +/−10% unless otherwise specified herein.

From the foregoing, it will be appreciated that example systems, apparatus, articles of manufacture, and methods have been disclosed that reduce the occurrence of noise and/or cavitation during operation (e.g., throttling) of a valve. An example valve assembly disclosed herein includes an example cage positioned between a fluid inlet and a fluid outlet of the valve assembly, where the cage includes example grooves positioned along one or more circumferences of an inner surface of the cage. Further, the valve assembly includes an example plug movable within the cage between an open position and a closed position. When the plug is in the open position, fluid from the fluid inlet can flow to the fluid outlet via successive stages of the grooves. In such examples, a pressure of the fluid drops in a gradual and/or staged manner as the fluid flows through the grooves, resulting in a reduction in cavitation and/or noise. Additionally, the grooves direct the fluid flow downward (e.g., toward the fluid outlet) and away from (e.g., radially outward) from the plug. By reducing flow of fluid and/or pressure onto the plug, disclosed examples can reduce wear of and/or damage to the plug. Disclosed systems, apparatus, articles of manufacture, and methods are accordingly directed to one or more improvement(s) in the operation of a machine or other electronic and/or mechanical device.

An example valve trim apparatus having grooves to reduce cavitation is disclosed herein. Further examples and combinations thereof include the following:

Example 1 includes a valve assembly comprising a valve body, a fluid inlet and a fluid outlet defined in the valve body, a cage positioned in the valve body between the fluid inlet and the fluid outlet, the cage including grooves in an inner surface of the cage, and a plug positioned in and movable within the cage between an open position and a closed position, the plug to restrict flow of fluid from the fluid inlet to the fluid outlet when the plug is in the closed position, the fluid to flow through the grooves from the fluid inlet to the fluid outlet when the plug is in the open position, the grooves to direct the fluid toward the fluid outlet and away from the plug.

Example 2 includes the valve assembly of any preceding clause(s) of example 1, wherein the grooves are first grooves spaced along a first circumference of the inner surface, and the cage further includes second grooves in the inner surface and spaced along a second circumference of the inner surface, the second grooves downstream from the first grooves, a first number of the first grooves less than a second number of the second grooves.

Example 3 includes the valve assembly of any preceding clause(s) of example 2, wherein the first grooves are slanted in a first direction relative to a longitudinal direction of the cage, the second grooves are slanted in a second direction relative to the longitudinal direction, the second direction different from the first direction.

Example 4 includes the valve assembly of any preceding clause(s) of example 3, wherein the cage further includes third grooves in the inner surface and spaced along a third circumference of the cage, the third grooves downstream from the first grooves and the second grooves, a third number of the third grooves greater than the first number of the first grooves and the second number of the second grooves, the third grooves slanted in the first direction.

Example 5 includes the valve assembly of any preceding clause(s) of any one or more of examples 1-4, wherein the plug includes a first hole extending along a longitudinal axis of the plug between a first surface and a second surface of the plug, and a second hole extending from the first hole to the first surface, the second hole angled relative to the longitudinal axis, the first hole and the second hole to fluidly couple the fluid outlet to a chamber defined between the first surface of the plug and the inner surface of the cage.

Example 6 includes the valve assembly of any preceding clause(s) of any one or more of examples 1-5, wherein the plug includes a stem portion, and a first flanged portion and a second flanged portion extending from the stem portion, the first flanged portion spaced apart from the second flanged portion in a longitudinal direction of the plug.

Example 7 includes the valve assembly of any preceding clause(s) of example 6, wherein the first flanged portion is to contact a valve seat defined in the inner surface when the plug is in the closed position.

Example 8 includes the valve assembly of any preceding clause(s) of any one or more of examples 1-7, wherein the cage further includes inlet ports extending in a radial direction from the inner surface to an outer surface of the cage, the inlet ports upstream of the grooves, the inlet ports to enable the fluid to flow from the fluid inlet to the inner surface.

Example 9 includes a valve trim comprising a cage to be positioned in a valve body between a fluid inlet and a fluid outlet of the valve body, the cage including grooves in an inner surface of the cage, and a plug positioned in and movable within the cage between an open position and a closed position, the plug to restrict fluid flow between the fluid inlet and the fluid outlet when the plug is in the closed position, the fluid to flow through the grooves from the fluid inlet to the fluid outlet when the plug is in the open position, the grooves to direct the fluid toward the fluid outlet and away from the plug.

Example 10 includes the valve trim of any preceding clause(s) of example 9, wherein the grooves are first grooves spaced along a first circumference of the inner surface, and the cage further includes second grooves in the inner surface and spaced along a second circumference of the inner surface, the second grooves downstream from the first grooves, a first number of the first grooves less than a second number of the second grooves.

Example 11 includes the valve trim of any preceding clause(s) of example 10, wherein the first grooves are slanted in a first direction relative to a longitudinal direction of the cage, the second grooves are slanted in a second direction relative to the longitudinal direction, the second direction different from the first direction.

Example 12 includes the valve trim of any preceding clause(s) of example 11, wherein the cage further includes third grooves in the inner surface and spaced along a third circumference of the cage, the third grooves downstream from the first grooves and the second grooves, a third number of the third grooves greater than the first number of the first grooves and the second number of the second grooves, the third grooves slanted in the first direction.
Example 13 includes the valve trim of any preceding clause(s) of any one or more of examples 9-12, wherein the plug includes a first hole extending along a longitudinal axis of the plug between a first surface and a second surface of the plug, and a second hole extending from the first hole to the first surface, the second hole angled relative to the longitudinal axis, the first hole and the second hole to fluidly couple the fluid outlet to a chamber defined between the first surface of the plug and the inner surface of the cage.
Example 14 includes the valve trim of any preceding clause(s) of any one or more of examples 9-13, wherein the plug includes a stem portion, and a first flanged portion and a second flanged portion extending from the stem portion, the first flanged portion spaced apart from the second flanged portion in a longitudinal direction of the plug.
Example 15 includes the valve trim of any preceding clause(s) of any one or more of examples 9-14, wherein the cage further includes inlet ports extending in a radial direction from the inner surface to an outer surface of the cage, the inlet ports upstream of the grooves, the inlet ports to enable the fluid to flow from the fluid inlet to the inner surface.
Example 16 includes a valve cage to be positioned in a valve body between a fluid inlet and a fluid outlet, the valve cage comprising an inner surface and an outer surface, fluid from the fluid inlet to flow from the outer surface to the inner surface and from the inner surface to the fluid outlet, and grooves in the inner surface, the grooves to direct the fluid toward the fluid outlet and away from a central longitudinal axis of the valve cage.
Example 17 includes the valve cage of any preceding clause(s) of example 16, wherein the grooves are first grooves spaced along a first circumference of the inner surface, further including second grooves in the inner surface and spaced along a second circumference of the inner surface, the second grooves downstream from the first grooves, a first number of the first grooves less than a second number of the second grooves.
Example 18 includes the valve cage of any preceding clause(s) of example 17, wherein the first grooves are slanted in a first direction relative to a longitudinal direction of the valve cage, the second grooves are slanted in a second direction relative to the longitudinal direction, the second direction different from the first direction.
Example 19 includes the valve cage of any preceding clause(s) of example 18, further including third grooves in the inner surface and spaced along a third circumference of the inner surface, the third grooves downstream from the first grooves and the second grooves, a third number of the third grooves greater than the first number of the first grooves and the second number of the second grooves, the third grooves slanted in the first direction.
Example 20 includes the valve cage of any preceding clause(s) of any one or more of examples 16-19, further including inlet ports extending from the inner surface to the outer surface in a radial direction, the inlet ports upstream of the grooves, the inlet ports to enable the fluid to flow from the fluid inlet to the inner surface.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A valve assembly comprising:
a valve body;
a fluid inlet and a fluid outlet defined in the valve body;
a cage positioned in the valve body between the fluid inlet and the fluid outlet, the cage including grooves in an inner surface of the cage; and
a plug positioned in and movable within the cage between an open position and a closed position, the plug to restrict flow of fluid from the fluid inlet to the fluid outlet when the plug is in the closed position, the fluid to flow through the grooves from the fluid inlet to the fluid outlet when the plug is in the open position, the grooves to direct the fluid toward the fluid outlet and away from the plug.

2. The valve assembly of claim 1, wherein the grooves are first grooves spaced along a first circumference of the inner surface, and the cage further includes second grooves in the inner surface and spaced along a second circumference of the inner surface, the second grooves downstream from the first grooves, a first number of the first grooves less than a second number of the second grooves.

3. The valve assembly of claim 2, wherein the first grooves are slanted in a first direction relative to a longitudinal direction of the cage, the second grooves are slanted in a second direction relative to the longitudinal direction, the second direction different from the first direction.

4. The valve assembly of claim 3, wherein the cage further includes third grooves in the inner surface and spaced along a third circumference of the cage, the third grooves downstream from the first grooves and the second grooves, a third number of the third grooves greater than the first number of the first grooves and the second number of the second grooves, the third grooves slanted in the first direction.

5. The valve assembly of claim 1, wherein the plug includes:
a first hole extending along a longitudinal axis of the plug between a first surface and a second surface of the plug; and
a second hole extending from the first hole to the first surface, the second hole angled relative to the longitudinal axis, the first hole and the second hole to fluidly couple the fluid outlet to a chamber defined between the first surface of the plug and the inner surface of the cage.

6. The valve assembly of claim 1, wherein the plug includes:
a stem portion; and
a first flanged portion and a second flanged portion extending from the stem portion, the first flanged portion spaced apart from the second flanged portion in a longitudinal direction of the plug.

7. The valve assembly of claim 6, wherein the first flanged portion is to contact a valve seat defined in the inner surface when the plug is in the closed position.

8. The valve assembly of claim 1, wherein the cage further includes inlet ports extending in a radial direction from the inner surface to an outer surface of the cage, the inlet ports upstream of the grooves, the inlet ports to enable the fluid to flow from the fluid inlet to the inner surface.

9. A valve trim comprising:
a cage to be positioned in a valve body between a fluid inlet and a fluid outlet of the valve body, the cage including grooves in an inner surface of the cage; and
a plug positioned in and movable within the cage between an open position and a closed position, the plug to restrict fluid flow between the fluid inlet and the fluid outlet when the plug is in the closed position, the fluid to flow through the grooves from the fluid inlet to the fluid outlet when the plug is in the open position, the grooves to direct the fluid toward the fluid outlet and away from the plug.

10. The valve trim of claim 9, wherein the grooves are first grooves spaced along a first circumference of the inner surface, and the cage further includes second grooves in the inner surface and spaced along a second circumference of the inner surface, the second grooves downstream from the first grooves, a first number of the first grooves less than a second number of the second grooves.

11. The valve trim of claim 10, wherein the first grooves are slanted in a first direction relative to a longitudinal direction of the cage, the second grooves are slanted in a second direction relative to the longitudinal direction, the second direction different from the first direction.

12. The valve trim of claim 11, wherein the cage further includes third grooves in the inner surface and spaced along a third circumference of the cage, the third grooves downstream from the first grooves and the second grooves, a third number of the third grooves greater than the first number of the first grooves and the second number of the second grooves, the third grooves slanted in the first direction.

13. The valve trim of claim 9, wherein the plug includes:
a first hole extending along a longitudinal axis of the plug between a first surface and a second surface of the plug; and
a second hole extending from the first hole to the first surface, the second hole angled relative to the longitudinal axis, the first hole and the second hole to fluidly couple the fluid outlet to a chamber defined between the first surface of the plug and the inner surface of the cage.

14. The valve trim of claim 9, wherein the plug includes:
a stem portion; and
a first flanged portion and a second flanged portion extending from the stem portion, the first flanged portion spaced apart from the second flanged portion in a longitudinal direction of the plug.

15. The valve trim of claim 9, wherein the cage further includes inlet ports extending in a radial direction from the inner surface to an outer surface of the cage, the inlet ports upstream of the grooves, the inlet ports to enable the fluid to flow from the fluid inlet to the inner surface.

16. A valve cage to be positioned in a valve body between a fluid inlet and a fluid outlet, the valve cage comprising:
an inner surface and an outer surface, fluid from the fluid inlet to flow from the outer surface to the inner surface and from the inner surface to the fluid outlet; and
grooves in the inner surface, the grooves to direct the fluid toward the fluid outlet and away from a central longitudinal axis of the valve cage.

17. The valve cage of claim 16, wherein the grooves are first grooves spaced along a first circumference of the inner surface, further including second grooves in the inner surface and spaced along a second circumference of the inner surface, the second grooves downstream from the first grooves, a first number of the first grooves less than a second number of the second grooves.

18. The valve cage of claim 17, wherein the first grooves are slanted in a first direction relative to a longitudinal direction of the valve cage, the second grooves are slanted in a second direction relative to the longitudinal direction, the second direction different from the first direction.

19. The valve cage of claim 18, further including third grooves in the inner surface and spaced along a third circumference of the inner surface, the third grooves downstream from the first grooves and the second grooves, a third number of the third grooves greater than the first number of the first grooves and the second number of the second grooves, the third grooves slanted in the first direction.

20. The valve cage of claim 16, further including inlet ports extending from the inner surface to the outer surface in a radial direction, the inlet ports upstream of the grooves, the inlet ports to enable the fluid to flow from the fluid inlet to the inner surface.
